(19) United States
(12) Patent Application Publication
(10) Pub. No.: US 2010/0246077 A1
(43) Pub. Date: Sep. 30, 2010

(54) ELECTROSTATIC DISCHARGE PROTECTION DEVICE OF OUTPUT DRIVER STAGE

(75) Inventors: Hong- Seok JEONG, Cheongju-si (KR); Dae-Keun HAN, Daejeon-si (KR); Dae-Seong KIM, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICON WORKS CO., LTD, Daejeon-si (KR)

(21) Appl. No.: 12/675,304

(22) PCT Filed: Jul. 29, 2008
(86) PCT No.: PCT/KR2008/004410

§ 371 Date: Feb. 25, 2010

(30) Foreign Application Priority Data
Aug. 30, 2007 (KR) 10-2007-0087349

(51) Int. Cl. H02H 9/04

(52) U.S. Cl. 361/56

(57) ABSTRACT

Provided is an electrostatic discharge (ESD) protection device of an output driver stage of a semiconductor chip. The ESD protection device of an output driver stage, which includes a p-channel metal-oxide-semiconductor (PMOS) transistor having a source connected to a first source voltage and an n-channel metal-oxide-semiconductor (NMOS) transistor having a source connected to a second source voltage, the MOS transistors having gates applied with output signals from an internal circuit and drains connected to the output pad, wherein a distance between contacts formed on a drain region and a gate poly of the MOS transistors is relatively greater than a value according to a predetermined design rule.

### BACKGROUND OF THE INVENTION

1. Field of the Invention

The present invention relates to an electrostatic discharge (ESD) protection device, and more particularly, to an ESD protection device of an output driver stage for preventing ESD from flowing into an internal circuit from the output driver stage.

2. Description of the Related Art

When electrostatic discharge (ESD) caused from the human body or machinery flows into an integrated semiconductor chip, internal microcircuits in the semiconductor chip may be damaged or generate errors. The ESD mainly flows into input/output driver stages of the semiconductor chip.

On the other hand, input driver stages of almost all semiconductor chips may include ESD protection devices. When a concept about the ESD for the output driver stages of semiconductor chips was not established, additional ESD protection devices were not used. However, recently, ESD protection devices for preventing ESD that may flow into the output driver stages of the semiconductor chips from flowing into internal circuits have been widely used.

FIG. 1 illustrates a conventional ESD protection device of an output driver stage.

Referring to FIG. 1, the conventional ESD protection device 100 of the output driver stage includes two diodes DP and DN and a limiting resistor R1. The limiting resistor R1 has a function of preventing the buildup of a discharge path of ESD toward a p-channel metal-oxide-semiconductor (PMOS) transistor P1 and an n-channel metal-oxide-semiconductor (NMOS) transistor N1 included in the output driver stage when ESD flows into an output pad. Instead, the ESD flows out through a discharge path formed at one of the two diodes DP and DN. Therefore, the ESD does not flow into an internal circuit 110.

However, the diodes DP and DN and the limiting resistor R1 for ESD protection of the output driver stage may result in increase in the entire chip size.

### SUMMARY OF THE INVENTION

The present invention provides an electrostatic discharge (ESD) protection device of an output driver stage capable of preventing ESD from flowing into an internal circuit in the output driver stage without diodes and limiting resistors.

According to an aspect of the present invention, there is provided an electrostatic discharge (ESD) protection device of an output driver stage, which includes a p-channel metal-oxide-semiconductor (PMOS) transistor having a source connected to a first source voltage and an n-channel metal-oxide-semiconductor (NMOS) transistor having a source connected to a second source voltage, the MOS transistors having gates applied with output signals from an internal circuit and drains connected to the output pad, wherein a distance between contacts formed on a drain region and a gate poly of the MOS transistors is relatively greater than a value according to a predetermined design rule.

According to another aspect of the present invention, there is provided an ESD protection device of an output driver stage, which includes a PMOS transistor P1 having a source connected to a first source voltage and an NMOS transistor having a source connected to a second source voltage, the MOS transistors having gates applied with output signals from an internal circuit and drains connected to the output pad, wherein a resistor is formed between the drain and the output pad of the MOS transistors.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional electrostatic discharge (ESD) protection device of an output driver stage;

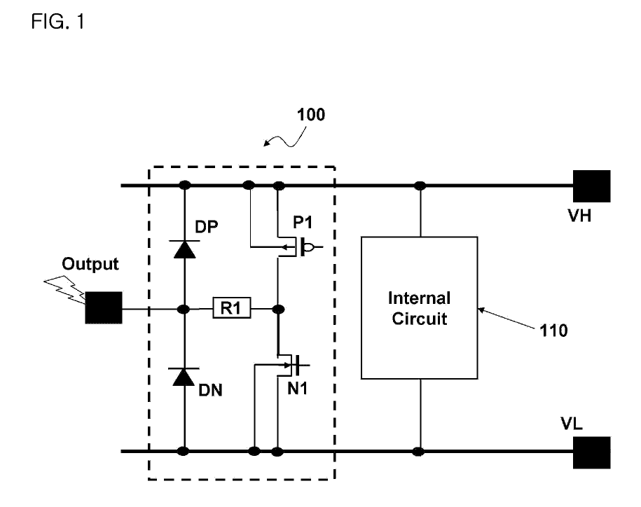

FIG. 2 illustrates an ESD protection device of an output driver stage according to an embodiment of the present invention;

FIG. 3 illustrates an example of implementing the ESD protection device illustrated in FIG. 2; and

FIG. 4 illustrates another example of implementing the ESD protection device illustrated in FIG. 2.

### DETAILED DESCRIPTION OF THE INVENTION

Exemplary embodiments of the present invention will now be described in detail with reference to the accompanying drawings.

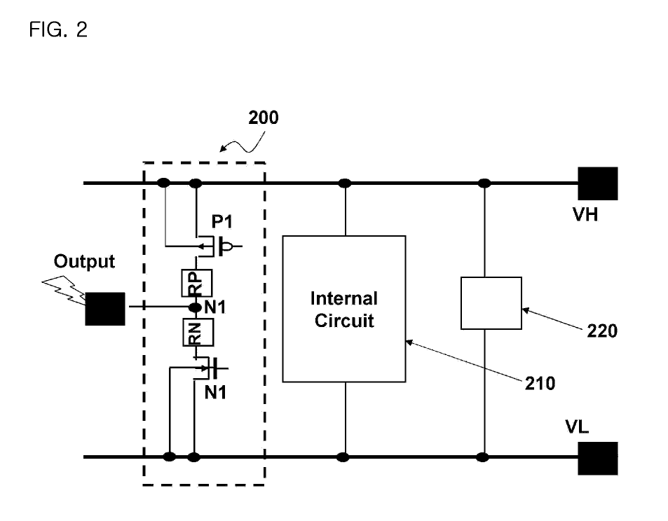

FIG. 2 illustrates an electrostatic discharge (ESD) protection device of an output driver stage according to an embodiment of the present invention.

An output driver stage 200 includes a p-channel metal-oxide-semiconductor (PMOS) transistor P1 and an n-channel metal-oxide-semiconductor (NMOS) transistor N1, and the PMOS transistor P1 and the NMOS transistor N1 are selectively turned on. In FIG. 2, the PMOS transistor P1 has a source connected to a first source voltage VH, a drain connected to a node N1 connected to an output pad, and a gate applied with an output signal from an internal circuit 210. The NMOS transistor N1 has a source connected to a second source voltage VL, a drain connected to a node N1 connected to the output pad, and a gate applied with the output signal from the internal circuit 210 similarly to the PMOS transistor P1. The first and second source voltages VH and VL have different voltage levels, and in FIG. 2, the first source voltage VH has a relatively higher voltage level than the second source voltage VL. However, the opposite case can also be implemented.

The ESD protection device of the output driver stage illustrated in FIG. 2 does not have conventional diodes DP and DN and a limiting resistor R1. Instead, a drain resistor, an active resistor, well resistors RN and RP, and the like may be included therein.

Here, for examples, for the drain resistor, in a MOS transistor manufacturing process, according to a design rule determined in consideration of electromagnetic characteristics, a minimum distance between a contact formed on a drain region and a gate poly is needed. Accordingly, the drain resistor necessarily exists. However, in a case where the MOS transistors are manufactured according to the determined design rule, a value of resistance of the drain resistor is not that high and not that effective for the ESD protection.

In a case where the distance between the contact formed on the drain region and the gate poly is increased, the drain resistor can have an increased value. In this case, referring to FIG. 2, if ESD flows into the output pad, most of the flow of ESD is consumed through the drain resistors RN and RP. Therefore, the ESD exerts no or less influence on the internal circuit 210.

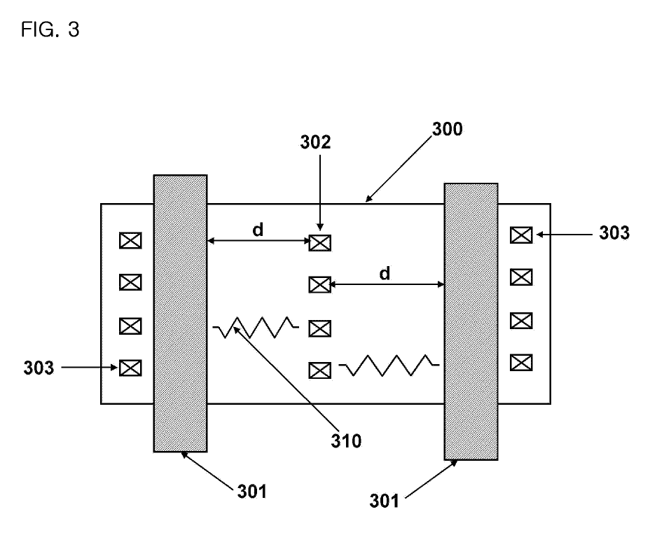

FIG. 3 illustrates an example of implementing the ESD protection device illustrated in FIG. 2.

Referring to FIG. 3, in an active region 300, a number of contacts 302 for drain output from each of MOS transistors P1 and N1 and a number of contacts 303 for source voltage connection to each of the MOS transistors, are formed in a vertical direction. In addition, on an upper portion of the active region 300, a gate poly 301 for forming a gate of each of the MOS transistors is formed.

Here, the gate poly 301 is disposed at predetermined intervals from the contacts 302 formed on a drain region and the contacts 303 formed on a source region. This applies the same concept as the aforementioned design rule. Here, an active region between the contacts 302 formed on the drain region and the gate poly 301 becomes a drain resistor 310. A value of resistance of the drain resistor 310 is determined by the distance d1 between the contacts 302 formed on the drain region and the gate poly 301. As the distance d1 between the contacts 302 formed on the drain region and the gate poly 301 is closer to a value according to the determined design rule, the value of resistance of the drain resistor 310 decreases. However, as the distance d1 between the contacts 302 formed on the drain region and the gate poly 301 increases, the value of resistance of the drain resistor 310 increases. As the value of resistance of the drain resistor 310 increases, a more amount of ESD flowing into the output pad is consumed.

Therefore, by increasing the distance d1 between the contacts 302 formed on the drain region and the gate poly 301 to be greater than the value according to the determined design rule, the ESD flowing into the output pad can be properly removed by the drain resistor 310 and prevented from flowing into the distance circuit 210, without the conventional diodes DP and DN and limiting resistor R1.

Here, when the distance d1 between the contacts 302 formed on the drain region and the gate poly 301 is increased, an area of the MOS transistor is also increased. However, removing the conventional diodes DP and DN and the limiting resistor R1 is much more effective than increasing the distance d1 between the contacts 302 formed on the drain region and the gate poly 301 to be greater than the value according to the determined design rule, in terms of the chip size. Therefore, a disadvantage of increasing the area of the MOS transistor can be overcome. The distance d1 between the contacts 302 formed on the drain region and the gate poly 301 may be increased by at least 5% from the value according to the determined design rule.

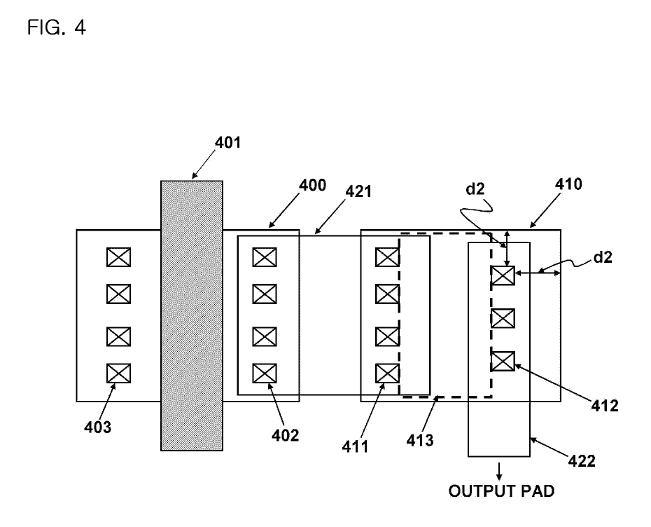

FIG. 4 illustrates another example of implementing the ESD protection device illustrated in FIG. 2. In FIG. 4, a more number of resistors are formed between a drain and an output pad of a MOS transistor.

In an active region 400, a number of contacts 402 formed on a drain region and a number of contacts 403 formed on a source region are formed. The resistors may be formed as an active region having a relatively higher impurity concentration or a well region having a relatively lower impurity concentration. If a relatively lower resistance is required, the active region is formed as the resistor, and if a relatively higher resistance is required, the well region is formed as the resistor.

Referring to FIG. 4, on the active region 410 functioning as the resistor, a number of contacts 411 relatively closer to the contacts 402 formed on the drain region and a number of contacts 412 relatively closer to the output pad are formed. Here, the contacts 411 relatively closer to the contacts 402 formed on the drain region become an equipotential by metal 421, and accordingly, the contacts 411 relatively closer to the contacts 402 formed on the drain region may be omitted.

The contacts 412 relatively closer to the output pad are connected to the output pad by metal 422. Here, in order to occupy an enough region to consume ESD in preparation for the inflow of the ESD, an overlap distance d2 of the contacts 412 relatively closer to the output pad may be increased by 5% from a value according to the determined design rule. Here, the overlap distance d2 of each of the contacts 412 relatively closer to the output pad means a distance occupied from the corresponding contact to an edge of the active region 410.

In the illustrated example of FIG. 4, a portion that practically serves the resistor is a region 413 between the contacts 411 relatively closer to the drain region and the contacts 413 relatively closer to the output pad. Therefore, when ESD flows into the output pad, most of the inflow of ESD is consumed by the region 413 that practically serves the resistor in the active region. Therefore, an enough ESD protection effect can be obtained through the aforementioned manner. In this case, the distance between the contacts 402 formed on the drain region and the gate poly 401 may be determined as the value according to the determined design rule.

In FIG. 2, in order to increase the ESD protection effect of the PMOS transistor P1 and the NMOS transistor N1, an ESD protection circuit 220 may further be included between the first and second source voltages VH and VL. Here, the ESD protection circuit 220 between the source voltages may be diodes connected in series, a bipolar transistor, or a combination thereof.

The electrostatic discharge (ESD) protection device of the output driver stage according to the present invention can prevent ESD that flows from the output pad from flowing into the internal circuit by increasing the drain resistors of the MOS transistors included in the output driver stage or using the active resistor. Therefore, the conventional diodes and limiting resistor are not needed and the entire chip size can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. An ESD (electrostatic discharge) protection device of an output driver stage, which includes a PMOS (p-channel metal-oxide-semiconductor) transistor having a source connected to a first source voltage and an NMOS (n-channel metal-oxide-semiconductor) transistor having a source connected to a second source voltage, the MOS transistors having gates applied with output signals from an internal circuit and drains connected to the output pad,
wherein a distance between contacts formed on a drain region and a gate poly of the MOS transistors is relatively greater than a value according to a predetermined design rule.

2. The ESD protection device of claim 1, wherein the interval between the contacts formed on the drain region and the gate poly of the MOS transistors is greater than the value according to the predetermined design rule by at least 5%.

3. An ESD protection device of an output driver stage, which includes a PMOS transistor P1 having a source connected to a first source voltage and an NMOS transistor having a source connected to a second source voltage, the MOS transistors having gates applied with output signals from an internal circuit and drains connected to the output pad,
wherein a resistor is formed between the drain and the output pad of the MOS transistors.

4. The ESD protection device of claim 3, wherein the resistor is formed as an active region or a well region.

5. The ESD protection device of claim 4, wherein an overlap distance of contacts relatively closer to the output pad from among contacts formed on the active region or the well region is relatively greater than a value according to a predetermined design rule.

6. The ESD protection device of claim 5, wherein the overlap distance of the contacts relatively closer to the output pad is greater than the value according to the predetermined design rule by at least 5%.

7. The ESD protection device of claim 1, further comprising an ESD protection circuit formed between the first and second source voltages.

8. The ESD protection device of claim 3, further comprising an ESD protection circuit formed between the first and second source voltages.
